(19) United States
(12) Patent Application Publication
(10) Pub. No.: US 2023/0327795 A1
(43) Pub. Date: Oct. 12, 2023

(54) INTRA-CARRIER SPECTRAL SHAPING FOR HIGH-BAUD RATE OPTICAL TRANSMISSION SIGNALS

(71) Applicant: Infinera Corp., San Jose, CA (US)

(72) Inventors: Jonathan M. Buset, San Jose, CA (US); Lan Liu, Cupertino, CA (US); Nisar Ahmed, Bellevue, WA (US); Thomas Gerard, Campbell, CA (US); Francisco Javier Vaquero Caballero, San Jose, CA (US)

(21) Appl. No.: 18/297,408

(22) Filed: Apr. 7, 2023

Related U.S. Application Data
(63) Continuation of application No. 63/329,220, filed on Apr. 8, 2022.

(51) Int. Cl. H04J 14/02

(52) U.S. Cl. CPC H04J 14/0212; H04J 14/0221

(57) ABSTRACT

A network element is disclosed herein. The network element comprises an add transceiver to generate a first optical signal having one or more optical channel; a line port optically coupled to an optical fiber link; an optical signal inspector operable to sample an optical power of one or more spectral slice of the one or more optical channel; a WSS operable to attenuate the one or more spectral slice of the first optical signal; a processor; and a memory storing instructions that cause the processor to: determine a sample power profile based on the optical power of the one or more spectral slices; generate an attenuation profile based on the sample power profile and a target power profile; and apply the attenuation profile to cause the WSS to shape the one or more spectral slices of the first optical signal into the second optical signal.

### CROSS-REFERENCE TO RELATED APPLICATIONS

This application claims priority to U.S. Provisional Patent Application No. 63/329,220, filed Apr. 8, 2022, the entire content of which is incorporated herein by reference in its entirety.

### DESCRIPTION OF THE PRIOR ART

Optical networking is a communication means that utilizes signals encoded in light to transmit information, e.g., data, as an optical signal in various types of telecommunications networks. Optical networking may be used in relatively short-range networking applications such as in a local area network (LAN) or in long-range networking applications spanning countries, continents, and oceans. Generally, optical networks utilize optical amplifiers, a light source such as lasers or LEDs, and wavelength division multiplexing to enable high-bandwidth communication.

Optical networks are a critical component of the global Internet backbone. This infrastructure acts as the underlay, providing the plumbing for all other communications to take place (e.g., access, metro, and long-haul). In the traditional 7-layer OSI model, Optical networks constitute the Layer 1 functions, providing digital transmission of bit streams transparently across varying distances over a chosen physical media (in this case, optical). Optical networks also encompass an entire class of devices (which are referred to as Layer 0), which purely deal with optical photonic transmission and wavelength division multiplexing (WDM). This includes amplification, (re-)generation, and optical add/drop multiplexing (OADM). The most widely adopted Layer 1/Layer 0 transport networking technologies today, referred to as Optical Transport Networks (OTN), are based on ITU-T standards. Both these classes of networks are connection-oriented and circuit-switched in nature.

Dense Wavelength Division Multiplexing (DWDM) is an optical transmission technology that uses a single fiber optic line to simultaneously transport multiple optical services of different wavelengths. The different wavelengths are conventionally separated into several frequency bands, each frequency band being used as an independent channel to transport optical services of particular wavelengths. The Conventional Band (C-band) typically includes signals with wavelengths ranging from 1530 nm to 1565 nm, is the frequency band in which optical services experience the lowest amount of loss, and is the band most commonly used in DWDM. The Long-wavelength Band (L-band), which typically includes signals with wavelengths ranging from 1565 nm to 1625 nm, is the frequency band in which optical services experience the second lowest amount of loss, and is the frequency band often used when the C-band is insufficient to meet bandwidth requirements. Optical line systems that use both the C-band and the L-band are referred to as C+L or C/L optical line systems.

C+L optical line systems may be susceptible to experiencing optical power transients during loading operations due to the Stimulated Raman Scattering (SRS) effect across the different frequency bands. This can lead to traffic drop on pre-existing services in one frequency band if there is a significant loading change in the other frequency band.

### SUMMARY OF THE INVENTION

In C+L-band networks, services in a particular band (i.e., the C-band or the L-band) should be carefully loaded to minimize the effects of optical power changes on pre-existing services in the other band. Additionally, the optical signal may be shaped during transmission due to fiber transmission characteristics and/or non-ideal network elements such as frequency dependent fiber losses, the fiber attenuation profile, amplifier gain ripple, WDM filter ripple, and/or stimulated Raman scattering SRS, and the like, for example.

Power targeting and balancing may be performed at varying levels, such as at the band level, the passband level, and an inter-carrier level. The band level may include optimizing amplifier gain and tilt settings for the aggregate optical signal transmitted on the optical fiber. The passband level may include optimizing the power spectral density of different passbands that contain one or more carrier. The inter-carrier level may include optimizing the power spectral density of multiple carriers within a single passband. In other words, for each of the above, power targeting and balancing is performed with carrier-granularity, e.g., the smallest bandwidth for which power targeting and balancing is performed is the bandwidth of the carrier.

In previous generation systems, an optical signal bandwidth was relatively low (e.g., 10 GHz, 25 GHz, 33 GHz, 50 GHz, etc.) and not significantly higher than both the WSS slice granularity and optical signal inspector slice granularity.

In these older systems, the total power of the carrier was balanced/attenuated by the WSS, but the shape (i.e., power spectral density profile) of the carrier was not considered, for example, due to hardware limitations affecting the measurement of the power density shape and the attenuation of the optical signal with a high accuracy and/or resolution.

Current and next generation transponders have signal bandwidth of, for example, 100 GHz, 150 GHz, and 200 GHz, or higher. These channels occupy a significant portion of spectrum in the band, and the power spectral density profile across the carrier becomes distorted as the signal propagates through the line system, e.g., due to optical transients as described.

Disclosed herein is an intra-carrier shaping process using a high-resolution optical signal inspector to measure the signal power profile and wavelength selective switches (WSS) to apply a corrective attenuation profile to achieve a target power profile within a single carrier. The shaping process may include a target power profile being a flat profile. Alternatively, the shaping process may include a target power profile being a shaped profile at the transmitter ROADM, to apply and/or maintain a desired pre-emphasis shape on the optical carrier to counteract filtering and/or transmission penalties. This is particularly useful for transponders utilizing digital sub-carriers whose power can be tuned individually.

In one implementation, the problems of mitigating or limiting transients in an optical network is solved by the network element disclosed herein. The network element comprises an add transceiver, a line port, an optical signal inspector, a wavelength selective switch, a processor, and a memory. The add transceiver is operable to generate a first optical signal having one or more optical channel, where each optical channel having one or more spectral slice. The line port is operable to be optically coupled to an optical fiber link. The optical signal inspector is operable to sample an optical power of one or more spectral slice of the one or more optical channel. The wavelength selective switch is operable to attenuate the one or more optical channel of the first optical signal into a second optical signal. And the memory comprises a non-transitory processor-readable medium storing processor-executable instructions that when executed by the processor cause the processor to: determine a sample power profile based on the optical power of the one or more spectral slices at a first period of time by the optical signal inspector; generate an attenuation profile based on the sample power profile and a target power profile; and apply the attenuation profile to the wavelength selective switch to cause the wavelength selective switch to shape the one or more spectral slices of the first optical signal into the second optical signal.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale, or in schematic in the interest of clarity and conciseness. Not every component may be labeled in every drawing. Like reference numerals in the figures may represent and refer to the same or similar element or function. In the drawings:

FIG. 1 is a block diagram of an exemplary implementation of an optical transport network constructed in accordance with the present disclosure.

FIG. 2 is a diagrammatic view of an exemplary one of the network elements of the optical network of FIG. 1 constructed in accordance with the present disclosure.

FIG. 3 is a diagrammatic view of an exemplary implementation of the in-line amplifier of the optical network of FIG. 1 constructed in accordance with the present disclosure.

FIG. 4A is a diagram of an exemplary implementation of an add transceiver of FIG. 2 constructed in accordance with the present disclosure.

FIG. 4B is a block diagram of an exemplary implementation of a drop transceiver constructed in accordance with the present disclosure.

FIGS. 5A, 5B, and 5C are diagrams of exemplary implementations of an optical signal in accordance with the present disclosure.

FIGS. 6A and 6B are diagrams of exemplary implementations of an optical carrier in accordance with the present disclosure.

FIG. 6C is a diagram of an exemplary implementation of the optical carrier of FIG. 6A having a different target power profile in accordance with the present disclosure.

FIG. 7 is a process flow diagram of an exemplary implementation of an intra-carrier shaping process constructed in accordance with the present disclosure.

### DETAILED DESCRIPTION

The following detailed description of exemplary embodiments/implementations refers to the accompanying drawings. The same reference numbers in different drawings may identify the same or similar elements.

Before explaining at least one implementation of the disclosure in detail, it is to be understood that the disclosure is not limited in its application to the details of construction, experiments, exemplary data, and/or the arrangement of the components set forth in the following description or illustrated in the drawings unless otherwise noted.

The disclosure is capable of other implementations or of being practiced or carried out in various ways. Also, it is to be understood that the phraseology and terminology employed herein are for purposes of description and should not be regarded as limiting.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments/implementations herein. This is done merely for convenience and to give a general sense of the inventive concept. This description should be read to include one or more and the singular also includes the plural unless it is obvious that it is meant otherwise. Further, use of the term “plurality” is meant to convey “more than one” unless expressly stated to the contrary.

As used herein, qualifiers like “about,” “approximately,” and combinations and variations thereof, are intended to include not only the exact amount or value that they qualify, but also some slight deviations therefrom, which may be due to manufacturing tolerances, measurement error, wear and tear, stresses exerted on various parts, and combinations thereof, for example.

The use of the term “at least one” or “one or more” will be understood to include one as well as any quantity more than one. In addition, the use of the phrase “at least one of X, Y, and Z” will be understood to include X alone, Y alone, and Z alone, as well as any combination of X, Y, and Z.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

As used herein, any reference to “one embodiment,” “an embodiment,” “some embodiments,” “one implementation,” “some implementations,” “an implementation,” “one example,” “for example,” or “an example” means that a particular element, feature, structure, or characteristic described in connection with the embodiment/implementation/example is included in at least one embodiment/implementation/example and may be used in conjunction with other embodiments/implementations/examples. The appearance of the phrase “in some embodiments” or “one example” or “in some implementations” in various places in the specification does not necessarily all refer to the same embodiment/implementation/example, for example.

Circuitry, as used herein, may be analog and/or digital components referred to herein as “blocks”, or one or more suitably programmed processors (e.g., microprocessors) and associated hardware and software, or hardwired logic. Also, “components” or “blocks” may perform one or more functions. The term “component” or “block” may include hardware, such as a processor (e.g., a microprocessor), a combination of hardware and software, and/or the like. Software may include one or more processor-executable instructions that when executed by one or more components cause the component to perform a specified function. It should be understood that the algorithms described herein may be stored on one or more non-transitory processor-readable mediums, such as a memory. Exemplary non-transitory memory may include random access memory, read-only memory, flash memory, and/or the like. Such non-transitory memory may be electrically based, optically based, and/or the like.

Software may include one or more processor-readable instruction that when executed by one or more component, e.g., a processor, causes the component to perform a specified function. It should be understood that the algorithms described herein may be stored on one or more non-transitory processor-readable medium, which is also referred to herein as a memory. Exemplary non-transitory processor-readable mediums may include random-access memory (RAM), a read-only memory (ROM), a flash memory, and/or a non-volatile memory such as, for example, a CD-ROM, a hard drive, a solid-state drive, a flash drive, a memory card, a DVD-ROM, a Blu-ray Disk, a disk, and an optical drive, combinations thereof, and/or the like. Such non-transitory processor-readable media may be electrically based, optically based, magnetically based, and/or the like. Further, the messages described herein may be generated by the components and result in various physical transformations.

As used herein, the terms “network-based,” “cloud-based,” and any variations thereof, are intended to include the provision of configurable computational resources on demand via interfacing with a computer and/or computer network, with software and/or data at least partially located on a computer and/or computer network.

The generation of laser beams for use as optical data channel signals is explained, for example, in U.S. Pat. No. 8,155,531, entitled “Tunable Photonic Integrated Circuits”, issued Apr. 10, 2012, and U.S. Pat. No. 8,639,118, entitled “Wavelength division multiplexed optical communication system having variable channel spacings and different modulation formats,” issued Jan. 28, 2014, which are hereby fully incorporated in their entirety herein by reference.

As used herein, an “optical communication path” and/or an “optical route” may correspond to an optical path and/or an optical light path. For example, an optical communication path may specify a path along which light is carried between two or more network entities along a fiber optic link, e.g., an optical fiber.

The optical network has one or more band. A band is the complete optical spectrum carried on the optical fiber. Depending on the optical fiber used and the supported spectrum which can be carried over long distances with the current technology, relevant examples of the same are: C-Band/L-Band/Extended-C-Band. As used herein, the C-Band is a band of light having a wavelength between about 1530 nm and about 1565 nm. The L-Band is a band of light having a wavelength between about 1565 nm and about 1625 nm. Because the wavelength of the C-Band is smaller than the wavelength of the L-Band, the wavelength of the C-Band may be described as a short, or a shorter, wavelength relative to the L-Band. Similarly, because the wavelength of the L-Band is larger than the wavelength of the C-Band, the wavelength of the L-Band may be described as a long, or a longer, wavelength relative to the C-Band.

As used herein, a spectral slice (a “slice”) may represent a spectrum of a particular size in a frequency band (e.g., 12.5 gigahertz (“GHz”), 6.25 GHz, 3.125 GHz, etc.). For example, a 4.8 terahertz (“THz”) frequency band may include 384 spectral slices, where each spectral slice may represent 12.5 GHz of the 4.8 THz spectrum. A slice may be the resolution at which the power levels can be measured by the optical power monitoring device. The power level being measured by the optical power monitoring device represents the total optical power carried by the portion of the band represented by that slice.

Spectral loading, or channel loading, is the addition of one or more channel to a specific spectrum of light described by the light's wavelength in an optical signal. When all channels within a specific spectrum are being utilized, the specific spectrum is described as fully loaded. A grouping of two or more channel may be called a channel group. Spectral loading may also be described as the addition of one or more channel group to a specific spectrum of light described by the light's wavelength to be supplied onto the optical fiber as the optical signal.

A WSS (Wavelength Selective Switch) is a component used in optical communications networks to route (switch) optical signals between optical fibers on a per-slice basis. Generally, power level controls can also be done by the WSS by specifying an attenuation level on a passband filter. A Wavelength Selective Switch is a programmable device having source and destination fiber ports where the source and destination fiber ports and associated attenuation can be specified for a particular passband with a minimum bandwidth. The minimum bandwidth may be, for example, a slice. In one implementation, for example, the wavelength selective switch is operable to apply an attenuation for a particular passband having a first bandwidth and the optical power monitoring device has a resolution of a second bandwidth. The first bandwidth and the second bandwidth may be different (for example, the first bandwidth may be 12.5 GHz and the second bandwidth may be 3.125 GHz). In this implementation, then, the WSS may have a different slice width than the optical power monitor slice width.

A reconfigurable optical add-drop multiplexer (ROADM) node is an all-optical subsystem that enables remote configuration of wavelengths at any ROADM node, in other words, a ROADM enables optical switching of an optical signal without requiring conversion of the optical signal from an optical domain into an electrical or digital domain. A ROADM is software-provisionable so that a network operator can choose whether a wavelength is added, dropped, or passed through the ROADM node. The technologies used within the ROADM node include wavelength blocking, planar lightwave circuit (PLC), and wavelength selective switching—though the WSS has become the dominant technology. A ROADM system is a metro/regional WDM or long-haul DWDM system that includes a ROADM node. ROADMs are often talked about in terms of degrees of switching, ranging from a minimum of two degrees to as many as eight degrees, and occasionally more than eight degrees. A “degree” is another term for a switching direction and is generally associated with a transmission fiber pair. A two-degree ROADM node switches in two directions, typically called East and West. A four-degree ROADM node switches in four directions, typically called North, South, East, and West. In a WSS-based ROADM network, each degree requires an additional WSS switching element. So, as the directions switched at a ROADM node increase, the ROADM node's cost increases.

An exemplary optical transport network consists of two distinct domains: Layer 0 (“optical domain” or “optical layer”) and Layer 1 (“digital domain”) data planes. Layer 0 is responsible for fixed or reconfigurable optical add/drop multiplexing (R/OADM) and optical amplification (EDFA or Raman) of optical channels and optical channel groups (OCG), typically within the 1530 nm-1565 nm range, known as C-Band. ROADM functions are facilitated via usage of a combination of colorless, directionless, and contentionless (CDC) optical devices, which may include wavelength selective switches (WSS), Multicast switches (MCS). Layer 0 may include the frequency grid (for example, as defined by ITU G.694.1), ROADMs, FOADMs, Amps, Muxes, Line-system and Fiber transmission, and GMPLS Control Plane (with Optical Extensions). Layer 1 functions encompass transporting client signals (e.g., Ethernet, SONET/SDH) in a manner that preserves bit transparency, timing transparency, and delay-transparency. The predominant technology for digital layer data transport in use today is OTN (for example, as defined by ITU G.709). Layer 1 may transport “client layer” traffic. Layer 1 may be a digital layer including multiplexing and grooming. The optical layer may further be divided into either an OTS layer or an OCH layer. The OTS layer refers to the optical transport section of the optical layer, whereas the OCH layer refers to one or more optical channels which are co-routed, e.g., together as multiple channels.

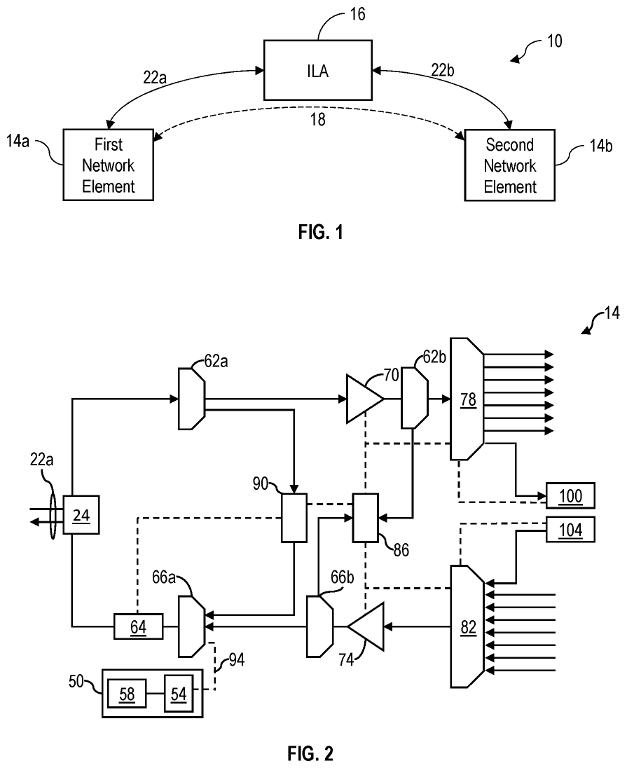

Referring now to the drawings, and in particular to FIG. 1, shown therein is a diagram of an exemplary implementation of an optical transport network 10 constructed in accordance with the present disclosure. The optical transport network 10 is depicted as having a plurality of network elements 14a-n, including a first network element 14a and a second network element 14b, and one or more in-line amplifier 16 optically disposed between the first network element 14a and the second network element 14b. Though two network elements 14 are shown for exemplary purposes, it will be understood that the plurality of network elements 14a-n may comprise more network elements 14. Data transmitted within the optical transport network 10 from the first network element 14a to the second network element 14b may travel along an optical path 18 formed from a first optical fiber link 22a, the in-line amplifier 16, and, a second optical fiber link 22b to the second network element 14b.

The optical transport network 10 may be, for example, considered as a graph made up of interconnected individual nodes (that is, the network elements 14 and in-line amplifiers 16). In one implementation, the optical transport network 10 may include any type of network that uses light as a transmission medium. For example, the optical transport network 10 may include a fiber-optic based network, an optical transport network, a light-emitting diode network, a laser diode network, an infrared network, a wireless optical network, a wireless network, combinations thereof, and/or other types of optical networks.

The number of devices and/or networks illustrated in FIG. 1 is provided for explanatory purposes. In practice, there may be additional devices and/or networks, fewer devices and/or networks, different devices and/or networks, or differently arranged devices and/or networks than are shown in FIG. 1. Furthermore, two or more of the devices illustrated in FIG. 1 may be implemented within a single device, or a single device illustrated in FIG. 1 may be implemented as multiple, distributed devices. Additionally, or alternatively, one or more of the devices of the optical transport network 10 may perform one or more functions described as being performed by another one or more of the devices of the optical transport network 10.

Referring now to FIG. 2, shown therein is a diagrammatic view of an exemplary one of the network elements 14a-n of optical transport network 10 constructed in accordance with the present disclosure. In general, the network element 14 transmits and receives data traffic and control signals. The first network element 14a and the second network element 14b may be constructed in accordance with the construction of the network element 14, described below.

As shown in FIG. 2, the network element 14 is a ROADM that connects to the first optical fiber link 22a via a line port 24. Each of the first optical fiber link 22a and the second optical fiber link 22b may include optical fiber pairs, wherein each fiber of the pair carries optical signal groups propagating in opposite directions. For simplicity, however, the network element 14 is shown as unidirectional with an optical signal propagating from the first optical fiber link 22a and through the second optical fiber link 22b. In one implementation, the network element 14 may be a ROADM within the optical path 18 of the optical transport network 10.

Nonexclusive examples of alternative implementations of the network element 14 include optical line terminals (OLTs), optical cross connects (OXCs), optical line amplifiers, optical add/drop multiplexer (OADMs) and/or reconfigurable optical add/drop multiplexers (ROADMs), interconnected by way of optical fiber links. OLTs may be used at either end of a connection or optical fiber link. OADM/ROADMs may be used to add, terminate and/or reroute wavelengths or fractions of wavelengths. Optical nodes are further described in U.S. Pat. No. 7,995,921 titled “Banded Semiconductor Optical Amplifiers and Waveblockers”, U.S. Pat. No. 7,394,953 titled “Configurable Integrated Optical Combiners and Decombiners”, and U.S. Pat. No. 8,223,803 (Application Publication Number 20090245289), titled “Programmable Time Division Multiplexed Switching,” the entire contents of each of which are hereby incorporated herein by reference in its entirety. The network element 14, as illustrated in FIG. 2, is a two-degree ROADM, however, in other implementations, the network element 14 may have more than two degrees.

In one implementation, the network element 14 may be provided with a controller 50 having circuitry including a processor 54 and a memory 58. The memory 58 may be a non-transitory processor-readable medium storing processor-executable instructions that when executed by the processor cause the processor 54 to perform one or more function or process, as described below.

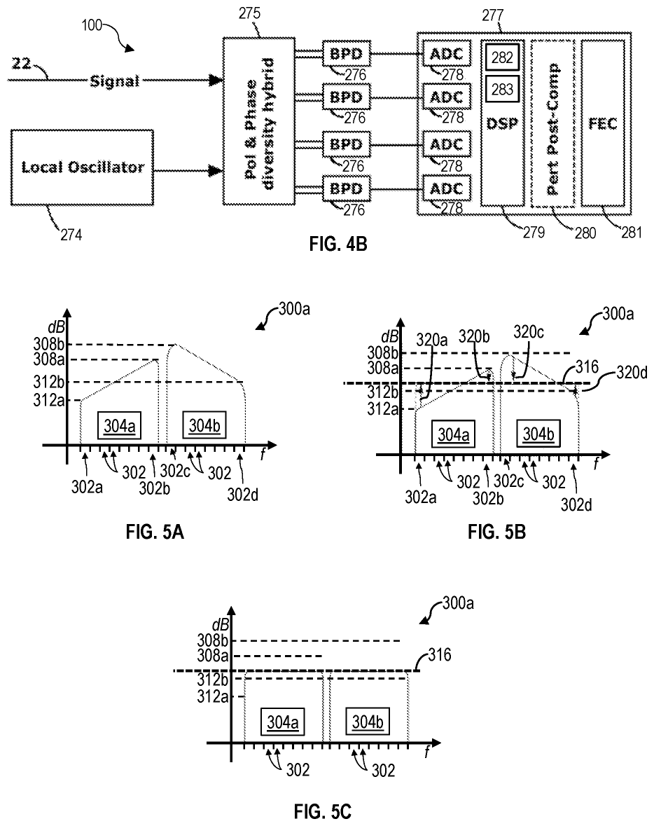

In one implementation, the network element 14 may further be provided with an input optical splitter 62, an output optical combiner 66, an input optical amplifier 70, an output optical amplifier 74, a demux WSS 78, a mux WSS 82, an optical signal inspector 86, and an optical supervisory channel (OSC) 90. In one implementation, at least one drop transceiver 100 (described below in more detail and shown in FIG. 4A), at least one add transceiver 104 (described below in more detail and shown in FIG. 4B), may be provided and in communication with the network element 14 to drop and add optical signals, respectively.

It should be noted that the elements of the network element 14 are shown for illustration purposes only and should not be considered limiting. For instance, the network element 14, as shown, is one possible realization of a single degree of a ROADM. However, the network element 14 may be implemented as a multi-degree ROADM with a launch power for each optical fiber link 22 serviced by the controller 50 of the network element 14 implemented in accordance with the inventive concepts described herein. Further, the at least one add transceiver 104 and the at least one drop transceiver 100 may be implemented as a line card having multiple add and drop transceivers and may be configured to service channels across multiple ROADM degrees.

The optical signal inspector 86 provides the ability to monitor a power level at one or more sample frequency of the optical signal with a sample resolution. The sample resolution may be, for example, between 12.5 GHz and 0.3125 GHz. In other implementations, the sample resolution may be less than 0.3125 GHz, for example, 0.15625 GHz or 78.125 MHz. For example, if the optical signal inspector 86 has a sample resolution of 12.5 GHz and the optical signal has a signal bandwidth of 125 GHz, the optical signal inspector 86 may slice the signal bandwidth into 10 spectral slices of 12.5 GHz where each spectral slice is centered on a particular sample frequency. The optical signal inspector 86 may thus determine the power level of each spectral slice for the optical signal based on the sample frequency for each spectral slice. In one implementation, as the optical signal inspector 86 determines a power level for a particular sample frequency, the power level/sample frequency pair is stored, for example, in the memory 58 by the processor 54. In one implementation, the optical signal inspector 86 may measure one or more optical characteristics of an optical signal, such as, for example, a power spectral density, a center frequency, an optical bandwidth, a shape, a channel slope, a channel roll-off, and/or the like or some combination thereof. In this way, the optical signal inspector 86 is operable to sample an optical power of one or more spectral slice. The optical signal inspector 86 can be implemented as an optical power monitor, the construction and use of which is known in the art.

This slice-wise power level data can then be used by the controller 50, e.g., processed by the processor 54 of the controller 50, to determine a sample power profile of the optical signal. The sample power profile, then, may be a set of sample frequency/power level pairs for each spectral slice. In one implementation, the sample power profile may be a power profile of a selected subset of spectral slices of the optical signal.

In one implementation, the processor 54 may include, but is not limited to, a digital signal processor (DSP), a central processing unit (CPU), a field programmable gate array (FPGA), a microprocessor, a multi-core processor, an application specific integrated circuit (ASIC), combinations, thereof, and/or the like, for example. The processor 54 is in communication with the memory 58 and may be operable to read and/or write to the memory 58.

In one implementation, the optical signal inspector 86 can also be used to troubleshoot the optical transport network 10. Recent innovations include flexible-grid optical channel monitors (OCMs) and higher-resolution coherent OCMs. Coherent OCMs offer sub-GHz frequency accuracy and highly accurate power monitoring of fine spectral slices independent of adjacent channel power. Coherent OCMs reduce the C-band scanning time from seconds to hundreds of milliseconds and provide advanced processing of spectral characteristics, such as valid channel detection, center wavelength, and optical signal-to-noise ratio (OSNR).

In one implementation, the OSC 90 provides a communication channel between adjacent nodes, such as the first network element 14a and the second network element 14b, that can be used for functions including link control, in-band management, control plane (i.e., ASON/GMPLS), and span loss measurement. Static information about physical properties of the optical fiber link 22 (fiber types, loss, amplifier types, etc.) downstream from the network element 14 can be communicated to the controller 50 via the OSC 90.

As shown in FIG. 2, the network element 14 may include the controller 50 for controlling components of the network element 14. The network element 14 may be provided with an interface 94 that connects the controller 50 to the components of the network element 14.

The number of devices illustrated in FIG. 2 are provided for explanatory purposes. In practice, there may be additional devices, fewer devices, different devices, or differently arranged devices than are shown in FIG. 2. Furthermore, two or more of the devices illustrated in FIG. 2 may be implemented within a single device, or a single device illustrated in FIG. 2 may be implemented as multiple, distributed devices. Additionally, one or more of the devices illustrated in FIG. 2 may perform one or more function described as being performed by another one or more of the devices illustrated in FIG. 2.

The network element 14 may include one or more wavelength selective switch, shown as the mux WSS 82 and the demux WSS 78. As described above, wavelength selective switches are components that can dynamically route, block and/or attenuate received optical signals input from and output to optical fiber links 22a-n. In addition to transmitting and/or receiving optical signals from the network element 14, optical signals may also be input from or output to the at least one add transceiver 104 and the at least one drop transceiver 100, respectively.

In one implementation, each WSS 78, 82 may be a reconfigurable, optical filter operable to allow one or more passbands (e.g., particular bandwidth(s) of the spectrum of the optical signal) to pass through or be routed as herein described.

In one implementation, the demux WSS 78 may be a DEMUX WSS, e.g., can receive optical signals and may be operable to selectively switch, or direct, such optical signals to one or more other WSS for output from the network element 14. The demux WSS 78 may also selectively or controllably supply optical signals to the drop transceiver 100. The mux WSS 82 may be a MUX WSS, e.g., operable to selectively receive optical signals from the add transceiver 104 in the network element 14 and from one or more express path, e.g., from an upstream network element 14. The optical signals output from the add transceiver 104 and/or from the express path may be selectively supplied to the mux WSS 82 for output to the first optical fiber link 22a.

In one implementation, the demux WSS 78, may be referred to as a DEMUX module and may apply attenuations and filtering, e.g., the attenuation profile described below, to an incoming optical signal before demultiplexing the incoming optical signal into one or more express optical signal or one or more drop optical signal.

In one implementation, the input optical amplifier 70 and/or the output optical amplifier 74 may be any optical amplifier configured to increase or supplement an optical power of the optical signal. For example, one or more of the input optical amplifier 70 and the output optical amplifier 74 may be an Erbium doped fiber amplifier (EDFA). In one implementation, one or more of the input optical amplifier 70 and the output optical amplifier 74 may further include a variable optical attenuator.

In one implementation, the network element 14 further includes an output variable optical attenuator 64 (e.g., VOA 64). The VOA 64 is an optical device operable to control attenuation (or insertion loss) according to an electrical control signal (e.g., received from the processor 54 of the controller 50 (described below)). The insertion loss may be, for example, a calibrated known value.

As shown in FIG. 2, a first optical signal enters the network element 14 via the first optical fiber link 22a and passes through the input optical amplifier 70 before being split at a second input optical splitter 62b where a sample portion of the first optical signal is directed to the optical signal inspector 86 while a remainder of the first optical signal continues to the demux WSS 78.

As shown in FIG. 2, the optical signal inspector 86 and the OSC 90 are shared for both directions of the first optical fiber link 22a. In other implementations, however, each direction may have a dedicated OSC 90 and/or a dedicated optical signal inspector 86.

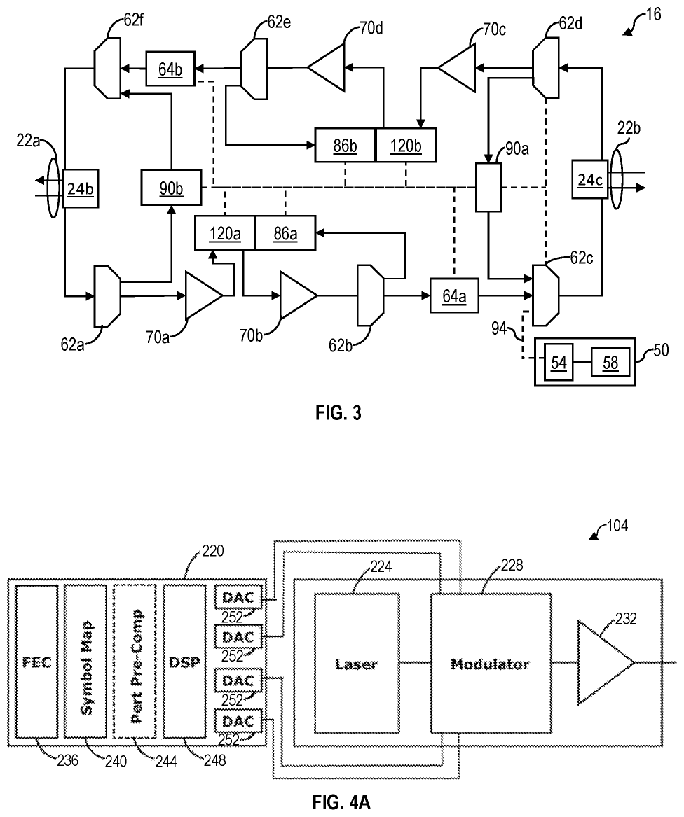

Referring now to FIG. 3, shown therein is a diagrammatic view of an exemplary implementation of the in-line amplifier 16 of the optical transport network 10 constructed in accordance with the present disclosure. In general, in-line amplifier 16 amplifies data traffic and receives and/or sends control signals.

As shown in FIG. 3, the in-line amplifier 16 is an optical in-line amplifier optically disposed between the first optical fiber link 22a via a first line port 24b and the second optical fiber link 22b via a second line port 24c. Each of the first optical fiber link 22a and the second optical fiber link 22b may include optical fiber pairs, wherein each fiber of the pair carries optical signal groups propagating in opposite directions. In one implementation, the in-line amplifier 16 may be an optical in-line amplifier within the optical path 18 of the optical transport network 10.

In one implementation, the in-line amplifier 16 may be provided with the controller 50 having the processor 54 and the memory 58, as described above.

In one implementation, the in-line amplifier 16, in a first direction (e.g., from the first optical fiber link 22a towards the second optical fiber link 22b), may further be provided with a first optical splitter 62a, a first amplifier 70a, a second amplifier 70b, the second input optical splitter 62b, a first variable optical attenuator 64a, a third optical splitter 62c, a first dynamic gain amplifier 120a (e.g., first DGE 120a), a first optical signal inspector 86a, a first OSC 90a, and a second OSC 90b. The in-line amplifier 16, in a second direction (e.g., from the second optical fiber link 22b towards the first optical fiber link 22a), may further be provided with a fourth optical splitter 62d, a third amplifier 70c, a fourth amplifier 70d, a fifth optical splitter 62e, a second variable optical attenuator 64b, a sixth optical splitter 62f, a second DGE 120b, and a second optical signal inspector 86b.

It should be noted that the elements of the in-line amplifier 16 are shown for illustration purposes only and should not be considered limiting. In some implementations, additional or fewer elements of the in-line amplifier 16 may be included in the in-line amplifier 16. For example, the in-line amplifier 16 may include photodetectors or other optical components.

In one implementation, the first DGE 120a and the second DGE 120b (collectively, DGE 120) is a dynamic gain equalizer (e.g., a dynamic gain-flattening filter). The DGE 120 is operable to attenuate an optical signal where the attenuation can be specified for at a resolution of a minimum bandwidth. The minimum bandwidth may be, for example, a slice. That is, the DGE 120 may attenuate the optical signal on a per-slice basis, e.g., apply an attenuation profile with a granularity of one spectral slice. The DGE 120 may be based on a planar lightwave circuit, MEMS, liquid crystal, and/or acousto-optic technology. In one implementation, the DGE 120 is operable to receive a control signal from the processor 54, e.g., via the interface 94, to attenuate the optical signal. In one implementation, the processor 54 of the controller 50 may transmit an attenuation profile to the DGE 120 and cause the DGE 120 to apply the attenuation profile to the optical signal, e.g., cause the DGE 120 to attenuate the optical signal by increasing the optical power at the one or more sample frequency. In one implementation, for example, the DGE 120, with a first minimum bandwidth, is operable to apply an attenuation profile to an optical signal and the optical signal inspector has a second resolution of a second minimum bandwidth. The first minimum bandwidth and the second minimum bandwidth may be different (for example, the first minimum bandwidth may be 6.25 GHz and the second minimum bandwidth may be 3.125 GHz). In this implementation, then, the DGE 120 may have a different slice width (e.g., the first minimum bandwidth/minimum resolution) than the optical signal inspector slice width (e.g., the second minimum bandwidth/second resolution).

The first optical signal inspector 86a and the second optical signal inspector 86b may be constructed in accordance with the optical signal inspector 86 described above. In one implementation, as shown in FIG. 3, the first optical signal inspector 86a and the first DGE 120a are combined into the same optical element, and the second optical signal inspector 86b and the second DGE 120b are combined into the same optical element. In other implementations, the first optical signal inspector 86a and the first DGE 120a are discrete optical elements and the second optical signal inspector 86b and the second DGE 120b are discrete optical elements. In yet another implementation, the first optical signal inspector 86a and the first DGE 120a are combined into the same optical element while the second optical signal inspector 86b and the second DGE 120b are discrete optical elements.

In one implementation, the first OSC 90a and the second OSC 90b provide a communication channel between adjacent nodes, such as the first network element 14a and the second network element 14b, that can be used for functions including link control, in-band management, control plane (i.e., ASON/GMPLS), and span loss measurement, as described above in relation to the OSC 90.

As shown in FIG. 3, the in-line amplifier 16 may include the controller 50 for controlling optical components of the in-line amplifier 16. The in-line amplifier 16 may be provided with the interface 94 that connects the controller 50 to the optical components of the in-line amplifier 16.

The number of devices illustrated in FIG. 3 are provided for explanatory purposes. In practice, there may be additional devices, fewer devices, different devices, or differently arranged devices than are shown in FIG. 3. Furthermore, two or more of the devices illustrated in FIG. 3 may be implemented within a single device, or a single device illustrated in FIG. 3 may be implemented as multiple, distributed devices. Additionally, one or more of the devices illustrated in FIG. 3 may perform one or more function described as being performed by another one or more of the devices illustrated in FIG. 3.

Referring now to FIG. 4A, shown therein is a diagram of an exemplary implementation of the add transceiver 104 of FIG. 2 constructed in accordance with the present disclosure. The add transceiver 104 may comprise one or more transmitter processor circuit 220, one or more laser 224, one or more modulator 228, one or more semiconductor optical amplifier 232, and/or other components (not shown). In one implementation, the add transceiver 104 is a coherent optical transceiver. In one implementation, the add transceiver 104 may have a transceiver bandwidth, such as 100 GHz, 200 GHz, or 400 GHz, for example.

The transmitter processor circuit 220 may have a Transmitter Forward Error Correction (FEC) circuitry 236, a Symbol Map circuitry 240, a transmitter perturbative pre-compensation circuitry 244, one or more transmitter digital signal processor (DSP) 248, and one or more digital-to-analogue converters (DAC) 252. The transmitter processor circuit 220 may be located in any one or more components of the add transceiver 104, or separate from the components, and/or in any location(s) among the components. The transmitter processor circuit 220 may be in the form of one or more Application Specific Integrated Circuit (ASIC), which may contain one or more module and/or custom module.

Processed electrical outputs from the transmitter processor circuit 220 may be supplied to the modulator 228 for encoding data into optical signals generated and supplied to the modulator 228 from the laser 224. The semiconductor optical amplifier 232 receives, amplifies, and transmits the optical signal including encoded data in the spectrum. Processed electrical outputs from the transmitter processor circuit 220 may be supplied to other circuitry in the transmitter processor circuit 220, for example, clock and data modification circuitry. The laser 224, modulator 228, and/or semiconductor optical amplifier 232 may be coupled with a tuning element (e.g., a heater) (not shown) that can be used to tune the wavelength of an optical signal channel output by the laser 224, modulator 228, or semiconductor optical amplifier 232. In some implementations, a single one of the laser 224 may be shared by multiple add transceiver(s) 104.

Other possible components in the add transceiver 104 may include filters, circuit blocks, memory, such as non-transitory memory storing processor executable instructions, additional modulators, splitters, couplers, multiplexers, etc., as is well known in the art. The components may be combined, used, or not used, in multiple combinations or orders. Optical transmitters are further described in U.S. Patent Publication No. 2012/0082453, the content of which is hereby incorporated by reference in its entirety herein.

Referring now to FIG. 4B, shown therein is a block diagram of an exemplary implementation of the drop transceiver 100 constructed in accordance with the present disclosure. The drop transceiver 100 may comprise one or more local oscillator 274, a polarization and phase diversity hybrid circuit 275 receiving the one or more channel from the optical signal and the input from the local oscillator 274, one or more balanced photodiode 276 that produces electrical signals representative of the one or more channel on the spectrum, and one or more receiver processor circuit 277. Other possible components in the drop transceiver 100 may include filters, circuit blocks, memory, such as non-transitory processor-readable memory storing processor-executable instructions, additional modulators, splitters, couplers, multiplexers, etc., as is well known in the art. The components may be combined, used, or not used, in multiple combinations or orders. The drop transceiver 100 may be implemented in other ways, as is well known in the art. Exemplary implementations of the drop transceiver 100 are further described in U.S. patent application Ser. No. 12/052,541, titled “Coherent Optical Receiver”, the entire contents of which are hereby incorporated by reference.

The one or more receiver processor circuit 277, may comprise one or more analog-to-digital converter (ADC) 278 receiving the electrical signals from the balanced photodiodes 276, one or more receiver digital signal processor (hereinafter, receiver DSP 279), receiver perturbative post-compensation circuitry 280, and receiver forward error correction circuitry (hereinafter, receiver FEC circuitry 281). The receiver FEC circuitry 281 may apply corrections to the data, as is well known in the art. The one or more receiver processor circuit 277 and/or the one or more receiver DSP 279 may be located on one or more component of the drop transceiver 100 or separately from the components, and/or in any location(s) among the components. The receiver processor circuit 277 may be in the form of an Application Specific Integrated Circuit (ASIC), which may contain one or more module and/or custom module. In one implementation, the receiver DSP 279 may include, or be in communication with, one or more processor 282 and one or more memory 283 storing processor readable instructions, such as software, or may be in communication with the processor 54 and the memory 58.

The one or more receiver DSP 279 may receive and process the electrical signals with multi-input-multiple-output (MIMO) circuitry, as described, for example, in U.S. Pat. No. 8,014,686, titled “Polarization demultiplexing optical receiver using polarization oversampling and electronic polarization tracking”, the entire contents of which are hereby incorporated by reference herein. Processed electrical outputs from receiver DSP 279 may be supplied to other circuitry in the receiver processor circuit 277, such as the receiver perturbative post-compensation circuitry 280 and the receiver FEC circuitry 281.

Various components of the drop transceiver 100 may be provided or integrated, in one example, on a common substrate. Further integration is achieved by incorporating various optical demultiplexer designs that are relatively compact and conserve space on the surface of the substrate.

In use, the one or more channel of the spectrum may be subjected to optical non-linear effects between the add transceiver 104 and the drop transceiver 100 such that the spectrum received does not accurately convey carried data in the form that the spectrum was transmitted.

Referring now to FIGS. 5A-C in combination, shown therein are diagrams of exemplary implementations of a first optical signal 300a at differing periods of time. Generally, FIG. 5A shows an optical spectrum having a first optical signal 300 prior to attenuation by either the DGE 120, the demux WSS 78, or the mux WSS 82 and shown with a plurality of spectral slices 302a-n (collectively, spectral slices 302). The first optical signal 300 within the optical spectrum may be considered an unattenuated optical signal. The first optical signal 300 is shown with a first optical channel 304a and a second optical channel 304b (collectively, optical channels 304). The optical channels 304 are shown with a ‘tilt’, that is, as the frequency, f, increases, an optical power of each optical channel 304 either increases (positive tilt, e.g., as shown by the first optical channel 304a) or decreases (negative tilt, e.g., as shown by the second optical channel 304b). Each optical channel 304 has an upper optical power 308 and a lower optical power 312, shown as first upper optical power 308a and first lower optical power 312a for the first optical channel 304a and as second upper optical power 308b and second lower optical power 312b for the second optical channel 304b.

In one implementation, the optical signal inspector 86, inspecting the first optical signal 300, may determine an optical power for each spectral slice 302 of each optical channel 304 (e.g., a spectral power density). For example, the optical signal inspector 86 may determine that a first sample optical power for a first spectral slice 302a as the first lower optical power 312a, a second sample optical power for a second spectral slice 302b as the first upper optical power 308a, a third sample optical power for a third spectral slice 302c as the second upper optical power 308b, and a fourth sample optical power for a fourth spectral slice 302d as the second lower optical power 312b.

Shown in FIG. 5B, the first optical signal 300 is shown having the first optical signal 300 prior to attenuation by either the DGE 120, the demux WSS 78, or the mux WSS 82 and is shown with the spectral slices 302. The first optical signal 300 within the optical spectrum may be considered an unattenuated optical signal. Further shown in FIG. 5B is a target power profile 316. The target power profile 316 shows a target power for each spectral slice 302. As shown, the target power profile 316 has a first target power for the first spectral slice 302a, a second target power for the second spectral slice 302b, a third target power for the third spectral slice 302c, and a fourth target power for the fourth spectral slice 302d. In this implementation, each of the first target power, the second target power, the third target power, and the fourth target power is the same, e.g., each spectral slice 302 has the same target power. In other implementations, as shown below, each spectral slice 302 may have a different target power than one or more other spectral slice 302.

In one implementation, the processor 54 may generate the attenuation profile based off of the target power profile and the sample power profile. The attenuation profile may be a difference between the target power profile 316 and the sample power profile. In one implementation, the processor 54 may generate the attenuation profile as a plurality of offsets 320 for each spectral slice 302 of each optical channel 304 of the first optical signal 300. For example, a first offset 320a for the first spectral slice 302a may be a difference between the first sample optical power (e.g., the first lower optical power 312a) and the target power profile 316, a second offset 320b for the second spectral slice 302b may be a difference between the second sample optical power (e.g., the first upper optical power 308a) and the target power profile 316, a third offset 320c for the third spectral slice 302c may be a difference between the third sample optical power (e.g., the second upper optical power 308b) and the target power profile 316, and a fourth offset 320d for the fourth spectral slice 302d may be a difference between the fourth sample optical power (e.g., the second lower optical power 312b) and the target power profile 316.

In one implementation, the processor 54 may generate the attenuation profile based off of the target power profile 316 and the sample power profile shifted by an applied gain. The attenuation profile may be a difference between the target power profile 316 and the sample power profile shifted by a largest offset 320 less than the target power profile 316. For example, in FIG. 5B, the first offset 320a is below the target power profile 316 and therefore optical power should be inserted at the first spectral slice 302a in order for the first spectral slice 302a to meet the target power profile 316. In one implementation, the processor 54 may cause one or more amplifier (such as the input optical amplifier 70 or output optical amplifier 74) to increase an optical signal power across the first optical channel 304a by at least the first offset 320a such that the optical power of each spectral slice 302 of the first optical channel 304a is at least as or above the target power profile 316. The attenuation profile, then, may be generated by the processor 54 such that application of the attenuation profile (e.g., by the DGE 120, the demux WSS 78, and/or the mux WSS 82) causes the optical power of each spectral slice 302 to approach the target power profile 316, e.g., may be within a predetermined margin of the target power profile 316.

In one implementation, the processor 54, after generating the attenuation profile, may cause one or more of the DGE 120, the demux WSS 78, and the mux WSS 82 to apply the attenuation profile to the optical signal, as shown in FIG. 5C. In one implementation, to limit further transients due to power changes in the power spectral density of the optical signal, for example, the processor 54 may cause one or more of the DGE 120, the demux WSS 78, and the mux WSS 82 to apply the attenuation profile gradually (e.g., in more than one iteration). For example, the attenuation profile may be applied in two iterations, wherein the processor 54 may cause one or more of the DGE 120, the demux WSS 78, and the mux WSS 82 to apply a first portion of the each offset of the attenuation profile across the optical signal in a first iteration and apply a second portion of each offset of the attenuation profile (or a remainder of the attenuation profile) across the optical signal in a second iteration. In one implementation, the second portion is less than the remainder (e.g., the second portion is less than the offset of the attenuation profile less the first portion).

Shown in FIG. 5C, the first optical signal 300 is shown having the first optical signal 300 after attenuation by one of the DGE 120, the demux WSS 78, or the mux WSS 82 and is shown with the spectral slices 302. The first optical signal 300 within the optical spectrum may be considered an attenuated optical signal as attenuation has been performed by one of the DGE 120, the demux WSS 78, or the mux WSS 82. As shown in FIG. 5C, a first optical power of the first spectral slice 302a has been increased to the first target power of the target power profile, a second optical power of the second spectral slice 302b has been decreased to the second target power of the target power profile, a third optical power of the third spectral slice 302c has been increased to the third target power of the target power profile, and a fourth optical power of the fourth spectral slice 302d has been decreased to the fourth target power of the target power profile.

In one implementation, the first optical signal 300 has more than two optical channels 304. For example, the first optical signal 300 may have 8 optical channels 304, or the first optical signal 300 may have 16 optical channels 304. In other implementations, the first optical signal 300 may have any number of optical channels 304 greater than or equal to the number of spectral slices 302 of the first optical signal 300.

In one implementation, the first optical signal 300 has more than 16 spectral slices 302. For example, a 4.8 terahertz (“THz”) frequency band may include 384 spectral slices, where each spectral slice may represent 12.5 GHz of the 4.8 THz spectrum. As spectral resolution of one or more of the DGE 120, the demux WSS 78, and the mux WSS 82 increases, the number of spectral slices 302 increases.

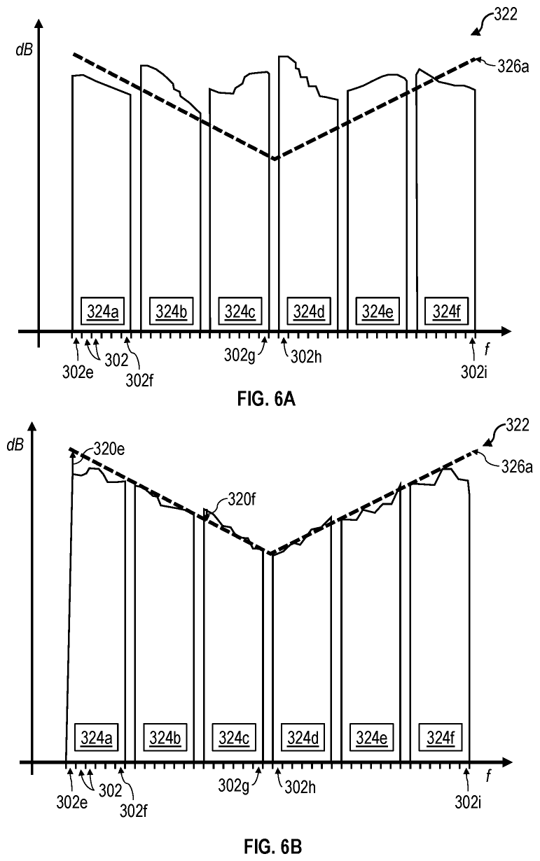

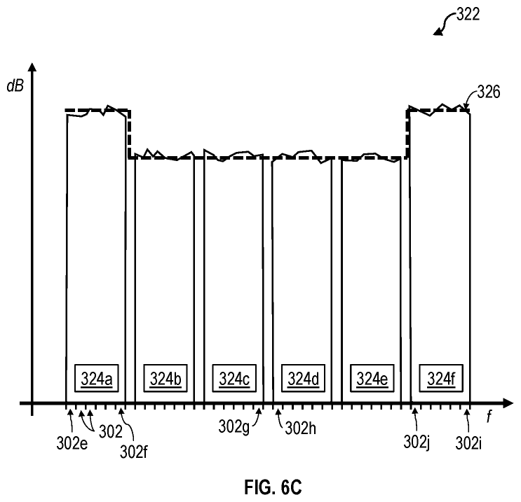

Referring now to FIGS. 6A-B, in combination, shown therein is a diagram of an exemplary embodiment of an optical carrier 322 before and after attenuation. Generally, FIG. 6A shows an optical spectrum having the optical carrier 322 prior to attenuation by either the DGE 120, the demux WSS 78, or the mux WSS 82 and shown with a plurality of optical subcarriers 324a-f. The optical carrier 322 within the optical spectrum may be considered an unattenuated optical signal. The optical carrier 322 is shown with a first optical subcarrier 324a, a second optical subcarrier 324b, a third optical subcarrier 324c, a fourth optical subcarrier 324d, a fifth optical subcarrier 324e, and a sixth optical subcarrier 324f. The optical subcarriers 324 are shown with unwanted shaping, that is, the shape of the optical subcarriers 324 has a spectral shape different from a first target power profile 326a. Shown in FIG. 6A, as the frequency, f, increases, the optical power of each optical subcarrier 324 varies.

As shown in FIG. 6A, the first target power profile 326a is a predetermined non-uniform shaped power profile having one or more pre-emphasized edge subcarrier of the one or more optical subcarrier 324 of the optical carrier 322. As shown, the first target power profile 326a (i.e., the predetermined non-uniform shaped power profile) has target powers that are not all the same for each spectral slice 302 of each optical subcarrier 324 of the optical carrier 322. In one implementation, the predetermined non-uniform shaped power profile may be applied to the optical signal (e.g., the optical carrier 322) to pre-emptively attenuate the optical signal in anticipation of optical filtering penalties the optical signal will experience during transmission, such that, the optical signal, when received by a downstream network element 14 (e.g., the second network element 14b), the optical signal has less undesired optical shaping due to the optical filtering penalties than if the optical signal had been transmitted with a flat target power profile (e.g., the first target power profile 316a).

For example, the first target power profile 326a has a fifth target power for a fifth spectral slice 302e and a sixth target power for a sixth spectral slice 302f where the fifth target power and the sixth target power are different. In one implementation, the one or more pre-emphasized edge subcarrier may be, for example, the first optical subcarrier 324a having a target power profile greater than the second optical subcarrier 324b and the sixth optical subcarrier 324f having a target power profile greater than the fifth optical subcarrier 324e.

As shown in FIG. 6B, the first target power profile 326a may be “V”-shaped, meaning that outer edge subcarriers (the first optical subcarrier 324a and the sixth optical subcarrier 324f) have a higher target power profile than inner edge subcarriers (the third optical subcarrier 324c and the fourth optical subcarrier 324d). In this implementation, outer-most spectral slices 302, the fifth spectral slice 302e and a ninth spectral slice 302i, may have a same first target optical power, while inner-most spectral slices 302, a seventh spectral slice 302g and an eighth spectral slice 302h, have a same second target optical power different from, and lesser than, the same first target optical power.

As shown in FIG. 6B, after the processor 54 determines the attenuation profile and causes one of the DGE 120, the demux WSS 78, or the mux WSS 82 to attenuate the optical carrier 322, e.g., each spectral slice 302 of each optical subcarrier 324 is attenuated, optical carrier 322 has a power profile that is similar to the first target power profile 326a.

It should be noted that, after a first attenuation, the optical signal (e.g., the optical carrier 322) may have one or more offset 320, e.g., offset 320e and offset 320f, for example. Therefore, in some implementations, an attenuation process (as described below) may be performed one or more additional instances to further attenuate the sample power profile into the target power profile, e.g., to further minimize the one or more offset 320.

As shown in FIG. 6C, a second target power profile 326b may be “U”-shaped, meaning that outer edge subcarriers (the first optical subcarrier 324a and the sixth optical subcarrier 324f) have a higher target power profile than inner subcarriers (the second optical subcarrier 324b through the fifth optical subcarrier 324e) and the inner subcarriers have a similar optical power. In this implementation, outer-most spectral slices 302 of the outer edge subcarriers, e.g., the fifth spectral slice 302e through the sixth spectral slice 302f and the ninth spectral slice 302i through a tenth spectral slice 302j, may have a same first target optical power, while inner-most spectral slices 302, e.g., all spectral slices between the tenth spectral slice 302j and the sixth spectral slice 302f, exclusive, and associated with an optical subcarrier 324, have a same second target optical power different from, and lesser than, the same first target optical power.

As shown in FIG. 6C, after the processor 54 determines the attenuation profile and causes one of the DGE 120, the demux WSS 78, or the mux WSS 82 to attenuate the optical carrier 322, e.g., each spectral slice 302 of each optical subcarrier 324 is attenuated, such that the optical carrier 322 has a power profile that is similar to the target power profile 326.

It should be noted that, after a first attenuation, the optical signal (e.g., the optical carrier 322) may still have one or more offset 320, for example. Therefore, in some implementations, an attenuation process (as described below) may be performed one or more additional instances to further attenuate the sample power profile (e.g., measured optical power of the optical carrier 322) into the target power profile, e.g., to further minimize the one or more offset 320.

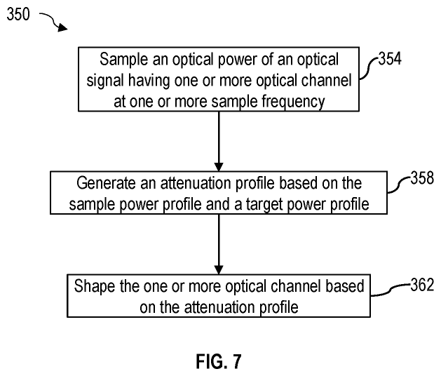

Referring now to FIG. 7, shown therein is a process flow diagram of an exemplary embodiment of an intra-carrier shaping process 350 constructed in accordance with the present disclosure. Generally, the intra-carrier shaping process 350 comprises: sampling an optical power of an optical signal having one or more optical channel (step 354); generating an attenuation profile based on the sample power profile and a target power profile (step 358); and attenuating one or more spectral slice of the one or more optical channel based on the attenuation profile (step 362). In one implementation, prior to the intra-carrier shaping process 350, inter-carrier optical shaping has equalized the average carrier power spectral densities, for example, if the optical signal has more than one channel.

In one implementation, sampling an optical power of an optical signal having one or more optical channel (step 354) includes measuring a sample optical power of one or more spectral slice of each optical channel of the optical signal by one or more optical signal inspector 86. In one implementation, the sample optical power is stored by the processor 54 in the memory 58.

In one implementation, sampling an optical power of an optical signal having one or more optical channel (step 354) includes measuring a sample optical power of each spectral slice 302 of the first optical signal 300; whereas in other implementations, step 354 includes measuring the sample optical power of each spectral slice 302 of optical channels 304.

In one implementation, sampling an optical power of an optical signal having one or more optical channel (step 354) may be performed continuously by the optical signal inspector 86. In one implementation, sampling an optical power of an optical signal having one or more optical channel (step 354) may be performed periodically by one or more optical signal inspector 86. In one implementation, sampling an optical power of an optical signal having one or more optical channel (step 354) may be performed by one or more optical signal inspector 86, as requested by the processor 54, e.g., via the interface 94.

In one implementation, sampling an optical power of an optical signal having one or more optical channel (step 354) may be performed by the optical signal inspector being one or more of an optical power monitor, an optical channel monitor, and an optical spectrum analyzer.

In one implementation, sampling an optical power of an optical signal having one or more optical channel (step 354) may include sampling a first optical power for each spectral slice of a first optical signal in a first direction and sampling a second optical power for each spectral slice of a second optical signal in a second direction, wherein the first direction is different from the second direction.

In one implementation, sampling an optical power of an optical signal having one or more optical channel (step 354) includes sampling the optical power of the optical signal after having been first attenuated.

In one implementation, sampling an optical power of an optical signal having one or more optical channel (step 354) includes sampling the optical signal based on a resolution of the dynamic gain equalizer or the wavelength selective switch, such as per spectral slice. For example, each spectral slice may have a bandwidth of 25 GHz, 12.5 GHz, 6.25 GHz, and 3.125 GHz, for example, and may have a bandwidth of less than 1 GHz.

In one implementation, sampling an optical power of an optical signal having one or more optical channel (step 354) includes sampling the optical power of each spectral slice of the optical signal and dropping any spectral slice outside one or more frequency of interest. The one or more frequency of interest may be, for example, one or more frequency of the optical signal having data. For example, the optical signal may be sliced into a plurality of spectral slices, some of which correspond to frequencies having data and some of which correspond to designated non-data frequencies, such as a carrier guard-band. The selected slice set may be a selection of the one or more spectral slices having data, or may be a selection of the one or more spectral slices excluding unutilized bandwidth, for example. In one implementation, the frequencies of interest may not include spectral slices on carrier edges as the bandwidth rolls off, or those prone to measurement error. For example, the frequencies of interest may include spectral slices other than those of a channel guard band, a channel roll-off guard band, a WSS guard band, a channel uncertainty guard band, and/or a frequency offset guard band, and the like, for example.

In one implementation, sampling an optical power of an optical signal having one or more optical channel (step 354) includes sampling the optical power of the one or more spectral slices of the one or more optical channel of the optical signal such that the spectral slices have a slice bandwidth and a slice frequency, as sliced by the optical signal inspector, that aligns with a WSS slice bandwidth and a WSS slice frequency of the wavelength selective switch. For example, if the wavelength selective switch is operable to attenuate spectral slices having the WSS slice bandwidth, the optical signal inspector may adjust slicing of the optical signal such that the spectral slices have the slice bandwidth equal to the WSS slice bandwidth and the slice frequency equal to the WSS slice frequency.

In one implementation, sampling an optical power of an optical signal having one or more optical channel (step 354) includes sampling the optical power of the one or more spectral slices of the one or more optical channel of the optical signal such that the spectral slices have a slice bandwidth and a slice frequency, as sliced by the optical signal inspector. The slice bandwidth may be, for example, 0.3125 GHz, whereas the wavelength selective switch may, when slicing the optical signal into WSS slices, have a WSS slice bandwidth and a WSS slice frequency where the WSS slice bandwidth is 12.5 GHz, 6.25 GHz, or 3.125 GHz, for example. In this implementation, generating the attenuation profile may further include resampling the spectral slices having the slice bandwidth into WSS slices having the WSS slice bandwidth. For example, the optical power of the spectral slices (with a 0.3125 GHz) may be averaged over each 10 consecutive slices, resulting in an average optical power for a slice having the WSS slice bandwidth, e.g., a 3.125 GHz slice for a WSS slice.

In one implementation, generating an attenuation profile based on the sample power profile and a target power profile (step 358) includes retrieving a target power profile by the processor 54. The processor 54 may retrieve the target power profile from the memory 58, for example, or may be provided the target power profile by a one or more user or other processor in the optical transport network 10.

In one implementation, generating an attenuation profile based on the sample power profile and a target power profile (step 358) includes retrieving the sample power profile from the memory 58, and calculating an offset between the sample power profile and the target power profile. In one implementation, calculating the offset between the sample power profile and the target power profile may be performed on a spectral slice-by-slice basis, that is, the offset may be determined for one or more spectral slice of the optical signal.

In one implementation, generating an attenuation profile based on the sample power profile and a target power profile (step 358) includes retrieving a target power profile for a particular spectral slice of the optical signal, retrieving a sample power profile for the particular spectral slice of the optical signal, calculating an offset for the particular spectral slice of the optical signal; and generating the attenuation profile for the particular spectral slice based on the offset for the particular spectral slice.

In one implementation, generating an attenuation profile based on the sample power profile and a target power profile (step 358) includes retrieving the target power profile from the memory 58, wherein the target power profile is a predetermined non-uniform shaped power profile having one or more pre-emphasized edge channel of the one or more optical channel of the optical signal.

In one implementation, generating an attenuation profile based on the sample power profile and a target power profile (step 358) includes retrieving the target power profile from the memory 58, wherein the target power profile is a predetermined non-uniform shaped power profile. In one implementation, the predetermined non-uniform shaped power profile has an arbitrary and/or fanciful shape. In another implementation, the predetermined non-uniform shaped power profile has a desirable shape operable to, when used to attenuate the optical signal, decrease optical transients.

In one implementation, generating an attenuation profile based on the sample power profile and a target power profile (step 358) includes retrieving the target power profile from the memory 58, wherein the target power profile is a predefined flat power profile for each optical channel of the one or more optical channel of the optical signal.

In one implementation, generating an attenuation profile based on the sample power profile and a target power profile (step 358) includes generating the attenuation profile for a selected slice set of the one or more spectral slices. For example, the optical signal may be sliced into a plurality of spectral slices, some of which correspond to frequencies having data and some of which correspond to designated non-data frequencies, such as a carrier guard-band. The selected slice set may be a selection of the one or more spectral slices having data, or may be a selection of the one or more spectral slices excluding unutilized bandwidth, for example. In one implementation, the selected slice set may not include spectral slices on carrier edges as the bandwidth rolls off, or those prone to measurement error. For example, the spectral slice set may include spectral slices other than those of a channel guard band, a channel roll-off guard band, a WSS guard band, a channel uncertainty guard band, and/or a frequency offset guard band, and the like, for example.

In one implementation, generating an attenuation profile based on the sample power profile and a target power profile (step 358) includes applying, by the processor 54, one or more predetermined modifications to the attenuation profile. For example, the processor 54 may retrieve the predetermined modifications from the memory 58 and apply the predetermined modifications to the attenuation profile before attenuating one or more spectral slice of the one or more optical channel based on the attenuation profile (step 362). The predetermined modifications may be a modification to the attenuation profile based on hardware limitations. For example, the predetermined modifications may cause the processor 54 to extrapolate, interpolate, clip, and/or smooth the attenuation profile.

In one implementation, generating an attenuation profile based on the sample power profile and a target power profile (step 358) includes the processor 54 renormalizing the attenuation profile to preserve any average optical power restrictions, if present. For example, if, after generating the attenuation profile based on the sample power and the target power profile would cause the average optical power of the optical signal to miss an average optical power target, the processor 54 may adjust the attenuation profile, either by increasing the average optical power or decreasing the average optical power as needed.

In one implementation, attenuating one or more spectral slice of the one or more optical channel based on the attenuation profile (step 362) includes transmitting, e.g., by the processor 54, the attenuation profile to one or more of a dynamic gain equalizer and a wavelength selective switch, such as the DGE 120, the demux WSS 78, and the mux WSS 82, and causing the one or more of the dynamic gain equalizer and the wavelength selective switch, such as the DGE 120, the demux WSS 78, and the mux WSS 82, e.g., via the interface 94, to shape, e.g., attenuate, the optical signal based on the attenuation profile.

In one implementation, attenuating one or more spectral slice of the one or more optical channel based on the attenuation profile (step 362) includes applying the attenuation profile, by the processor 54, to one or more of the dynamic gain equalizer and the wavelength selective switch wherein the attenuation profile is one of a relative offset profile or an absolute attenuation profile. For example, the relative offset profile may be, for each spectral slice, a difference between the sample power profile and the target power profile. The absolute attenuation profile may be a calculated optical power to be applied to each of the one or more spectral slices.

In one implementation, attenuating one or more spectral slice of the one or more optical channel based on the attenuation profile (step 362) includes attenuating the one or more spectral slice based on the calculated offset for each of the one or more spectral slice.

In one implementation, attenuating one or more spectral slice of the one or more optical channel based on the attenuation profile (step 362) includes the processor 54 causing one or more of the dynamic gain equalizer and the wavelength selective switch, such as the DGE 120, the demux WSS 78, and the mux WSS 82 to apply the offset to the particular spectral slice.

In one implementation, attenuating the one or more spectral slice of the one or more optical channel based on the attenuation profile (step 362) further includes attenuating the one or more spectral slice based on the attenuation profile shifted by an applied gain. The attenuation profile may be a difference between the target power profile 316 and the sample power profile shifted by a largest offset 320 less than the target power profile 316 (as detailed above in relation to FIG. 5B). In this implementation, the processor 54 may first cause the one or more amplifier (such as the input optical amplifier 70 or the output optical amplifier 74) to increase an optical power across the first optical signal by at least the largest offset 320 less than the target profile such that the optical power of each spectral slice 302 of the optical signal is at least at or above the target power profile 316. The attenuation profile may then be applied such that all offsets result in a reduction in the optical power for one or more spectral slice, thereby causing the optical power of each spectral slice 302 to approach the target power profile.

In one implementation, the intra-carrier shaping process 350 may be performed more than one time for each optical signal. For example, once the intra-carrier shaping process 350 has completed, the intra-carrier shaping process 350 may be restarted. In one implementation, the intra-carrier shaping process 350 may be performed continuously. In one implementation, the intra-carrier shaping process 350 may be performed on a per-slice basis, and may be performed on more than one spectral slice as a time. In one implementation, the intra-carrier shaping process 350 may be performed until the second optical signal either reaches the target power profile or reaches a steady state, e.g., due to optical hardware limits.

In one implementation, the intra-carrier shaping process 350 may be performed in a ROADM MUX direction, a ROADM DEMUX direction, and across the in-line amplifier 16. As shown in FIG. 2, in the ROADM DEMUX direction, an incoming optical signal is measured by the optical signal inspector 86 prior to passing through the demux WSS 78, where the intra-carrier shaping process 350 applies the attenuation profile. In this case, output from the demux WSS 78 is not measured by the optical signal inspector 86. However, in the ROADM MUX direction, an outgoing optical signal is measured by the optical signal inspector 86 after passing through the mux WSS 82, where the intra-carrier shaping process 350 applies the attenuation profile. In this case, the optical signal inspector 86 may monitor shaping of the outgoing optical signal and, by repeating the intra-carrier shaping process 350, may further adjust the outgoing optical signal such that the outgoing optical signal approaches and/or meets the target power profile.

From the above description, it is clear that the inventive concept(s) disclosed herein are well adapted to carry out the objects and to attain the advantages mentioned herein, as well as those inherent in the inventive concept(s) disclosed herein. While the implementations of the inventive concept(s) disclosed herein have been described for purposes of this disclosure, it will be understood that numerous changes may be made and readily suggested to those skilled in the art which are accomplished within the scope and spirit of the inventive concept(s) disclosed herein.

What is claimed is:

1. A network element, comprising:
an add transceiver operable to generate a first optical signal, the first optical signal having one or more optical channel, each optical channel having one or more spectral slice;
a line port operable to be optically coupled to an optical fiber link;
an optical signal inspector operable to sample an optical power of one or more spectral slice of the one or more optical channel;
a wavelength selective switch operable to attenuate the one or more optical channel of the first optical signal into a second optical signal;
a processor; and
a memory comprising a non-transitory processor-readable medium storing processor-executable instructions that when executed by the processor cause the processor to:
determine a sample power profile based on the optical power of the one or more spectral slices at a first period of time by the optical signal inspector;
generate an attenuation profile based on the sample power profile and a target power profile; and
apply the attenuation profile to the wavelength selective switch to cause the wavelength selective switch to shape the one or more spectral slices of the first optical signal into the second optical signal.

2. The network element of claim 1, wherein the sample power profile is a first sample power profile and wherein the memory further stores processor-executable instructions that, when executed, cause the processor to:
determine a second sample power profile based on the optical power of the one or more spectral slices at a second period in time; and
generate the attenuation profile based on the second sample power profile and the target power profile.

3. The network element of claim 1, wherein the wavelength selective switch is disposed between the line port and the optical signal inspector.

4. The network element of claim 1, wherein the wavelength selective switch is a first wavelength selective switch; and further comprising:
a second line port operable to be optically coupled to the optical fiber link carrying a third optical signal;
a drop transceiver operable to receive the third optical signal, the third optical signal having one or more third optical channel, each third optical channel having one or more second spectral slice;
the optical signal inspector being further operable to sample a second optical power of the one or more second spectral slice of the one or more third optical channel;
a second wavelength selective switch operable to attenuate the one or more third optical channel of the third optical signal into one or more fourth optical signal;
the memory further storing processor-executable instructions that cause the processor to:
determine a second sample power profile based on the second optical power of the one or more second spectral slices at a first period of time;
generate a second attenuation profile based on the second sample power profile and a second target power profile; and
apply the second attenuation profile to the second wavelength selective switch to cause the second wavelength selective switch to attenuate the one or more spectral slices of the first optical signal into the one or more fourth optical signal;
wherein the optical signal inspector is disposed between the wavelength selective switch and the second line port.

5. The network element of claim 1, wherein the optical signal inspector is one or more of an optical power monitor, optical channel monitor, and optical spectrum analyzer.

6. The network element of claim 1, wherein the target power profile is a predefined flat power profile for each optical channel of the one or more optical channel of the first optical signal.

7. The network element of claim 1, wherein the target power profile is a predetermined non-uniform shaped power profile having one or more pre-emphasized edge channel of the one or more optical channel of the first optical signal.

8. An in-line amplifier, comprising:
a first line port operable to receive a first optical signal from a first optical fiber link, the first optical signal having one or more optical channel, each optical channel having one or more spectral slice;
a second line port operable to transmit a second optical signal to a second optical fiber link;
an optical signal inspector operable to sample an optical power of one or more spectral slice within the first optical signal;
a dynamic gain equalizer operable to attenuate the one or more spectral slice of the first optical signal into the second optical signal;
a processor; and
a memory comprising a non-transitory processor-readable medium storing processor-executable instructions that when executed by the processor cause the processor to:
determine a sample power profile based on the optical power of the one or more spectral slice;
generate an attenuation profile based on the sample power profile and a target power profile; and
apply the attenuation profile to the dynamic gain equalizer to cause the dynamic gain equalizer to attenuate the one or more spectral slice of at least one optical channel of the first optical signal into the second optical signal.

9. The in-line amplifier of claim 8, wherein the sample power profile is a first sample power profile and wherein the memory further stores processor-executable instructions that, when executed, cause the processor to:
determine a second sample power profile based on the optical power at the one or more spectral slice at a second period in time; and
generate the attenuation profile based on the second sample power profile and the target power profile.

10. The in-line amplifier of claim 8, wherein the dynamic gain equalizer is disposed between the first line port and the optical signal inspector.

11. The in-line amplifier of claim 8, wherein the optical signal inspector is one or more of an optical power monitor, optical channel monitor, and optical spectrum analyzer.

12. The in-line amplifier of claim 8, wherein the target power profile is a predefined flat power profile for each spectral slice of the one or more optical channel of the first optical signal.

13. The in-line amplifier of claim 8, wherein the target power profile is a predetermined non-uniform shaped power profile having one or more pre-emphasized edge channel of the one or more optical channel of the first optical signal.

14. The in-line amplifier of claim 8, wherein the optical signal inspector and the dynamic gain equalizer are integrated into an optical component.

15. The in-line amplifier of claim 8, wherein the dynamic gain equalizer is a wavelength selective switch.

16. A method comprising:
sampling an optical power of one or more spectral slice of one or more optical channel of an optical signal as a sample power profile;
generating an attenuation profile based on the sample power profile and a target power profile; and
shaping the one or more spectral slice of the optical signal based on the attenuation profile.

17. The method of claim 16, wherein sampling the optical power at one or more sample frequency includes sampling the optical power of the one or more spectral slice by one or more of an optical power monitor, and optical channel monitor, and an optical spectrum analyzer.

18. The method of claim 17, wherein sampling the optical power of the one or more spectral slice further includes sampling the optical power of the one or more spectral slice wherein each spectral slice has a bandwidth of between 12.5 GHz and 0.3125 GHz, inclusive.

19. The method of claim 16, wherein the attenuation profile is a first attenuation profile, sampling the optical power further comprises sampling the optical power of the one or more spectral slice of one or more optical channel of the optical signal for a first period of time as a first sample power profile, and further comprising:
sampling the optical power of the one or more spectral slice of the one or more optical channel of the optical signal for a second period of time as a second sample power profile, the second period of time being different from the first period of time;
generating a second attenuation profile based on the second sample power profile and the target power profile; and
attenuating the one or more spectral slice of at least one of the one or more optical channel based on the second attenuation profile.

20. The method of claim 16, wherein generating the attenuation profile further includes generating the attenuation profile based on the sample power profile and the target power profile, wherein the target power profile is a predetermined non-uniform shaped power profile having one or more pre-emphasized edge channel of the one or more optical channel of the optical signal.
